(19) United States
(12) Patent Application Publication
(10) Pub. No.: US 2007/0095912 A1
(43) Pub. Date: May 3, 2007

(54) Card reader access through battery compartment

(75) Inventors: Ed Lipscomb, Lakeville, MN (US); Manokar Chinnadurai, Owatonna, MN (US); Durval Ribeiro, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/212,662

(22) Filed: Aug. 29, 2005

(51) Int. Cl. G06K 7/06

(52) U.S. Cl. 235/441

(57) ABSTRACT

An apparatus and method are provided to prevent a memory card from disengaging a card reader portion of a scan tool until desired by a user. The card reader can be placed near or in a battery compartment so that the battery compartment cover can cover at least a portion of the battery compartment and at least a portion of the card reader. The user can simply remove the cover in order to have access to the card reader and insert the appropriate memory card.

### FIELD OF THE INVENTION

The present invention relates generally to an automotive scan tool. More particularly, the present invention relates to an automotive scan tool having a memory card reader accessed through a battery compartment.

### BACKGROUND OF THE INVENTION

Virtually all-modern automotive scan tools use expandable storage memory based on flash memory devices such as compact flash, secure digital, memory stick, etc. (collectively “memory card”) in order to save data or to update software on the scan tool. A user would typically insert the memory card into a memory card reader located on the periphery of the scan tool. However, the memory card reader does not have a cover that prevents the memory card from accidentally falling out during use, transport or if the scan tool is dropped. Adding additional covers will increase the costs of the scan tool.

Accordingly, it is desirable to provide a method and apparatus that will prevent the memory card from accidentally falling out of the scan tool.

### SUMMARY OF THE INVENTION

The foregoing needs are met, to a great extent, by the present invention, wherein in one aspect an apparatus is provided that in some embodiments a scan tool includes a battery cover that can cover at least a portion of a battery compartment and a card reader.

In accordance with one embodiment of the present invention, a scan too includes a housing to contain components of the scan tool, a card reader contained in the housing and configured to receive a memory card, and a cover that covers at least a portion of a battery compartment and at least a portion of the card reader.

In accordance with another embodiment of the present invention, a method of preventing a memory card from disengaging from a scan tool, includes providing a card reader within a housing of the scan tool, the card reader can be configured to communicate with the memory card, inserting the memory card into the card reader, and preventing the memory card from disengaging the card reader with a battery cover that can be received by the housing.

In accordance with yet another embodiment of the present invention, a scan tool system that includes means for housing that can contain components means of the scan tool, means for reading a memory storing means that can be contained in the means for housing and configured to receive the memory storing means, and means for covering that can cover at least a portion of a battery containing means and at least a portion of means for reading.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view illustrating a scan tool according to an embodiment of the invention.

FIG. 2 is a block diagram of the scan tool according to an embodiment of the invention.

FIG. 3 is a rear view of the scan tool according to an embodiment of the invention

FIG. 4 illustrates the scan tool with the battery cover removed.

FIG. 5 illustrates an end view of the scan tool with the battery cover removed according to an embodiment of the invention.

### DETAILED DESCRIPTION

The invention will now be described with reference to the drawing figures, in which like reference numerals refer to like parts throughout. An embodiment in accordance with the present invention provides for a scan tool having a cover for the memory card, wherein the cover is also the battery cover.

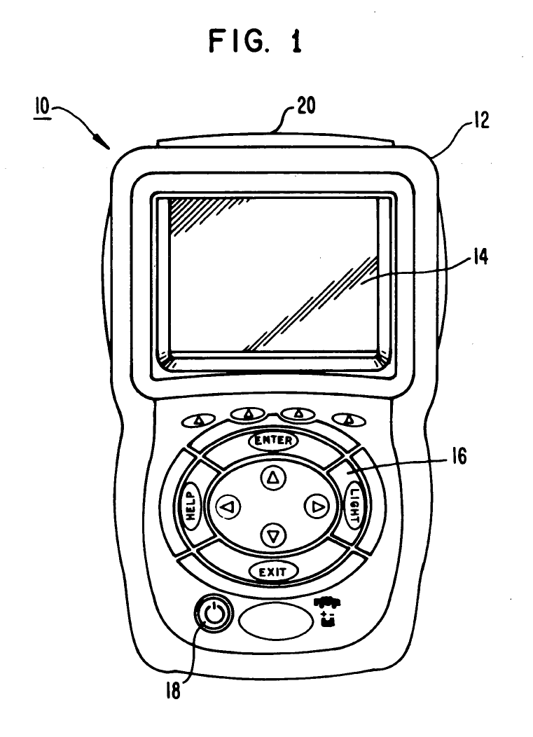

FIG. 1 is a front view illustrating a scan tool 10 according to an embodiment of the invention. The scan tool can be any scan tool that is known in the art. For example, the Nemisys scan tool from Service Solutions (a unit of the SPX corporation) in Owatonna, Minn. The scan tool 10 includes a housing 12 to house the various components of the scan tool, such as a screen 14, a user interface 16, a power key 18 and a connector interface 20. The screen 14 can be any screen, for example, LCD (liquid crystal display), VGA (video graphics array), touch screen, etc. The user interface 16 allows the user to interact with the scan tool in order to operate the scan tool as desired. The user interface 16 can include function keys, arrow keys or any other type of keys that can manipulate the scan tool. The power key 18 allows the user to turn the scan tool on and off as required. The connector interface 20 allows the scan tool to connect to an external device, such as an ECU (electronic control unit) of a vehicle, a computing device, an external communication device (such as a modem), a network, etc. through a cabled or wireless connection.

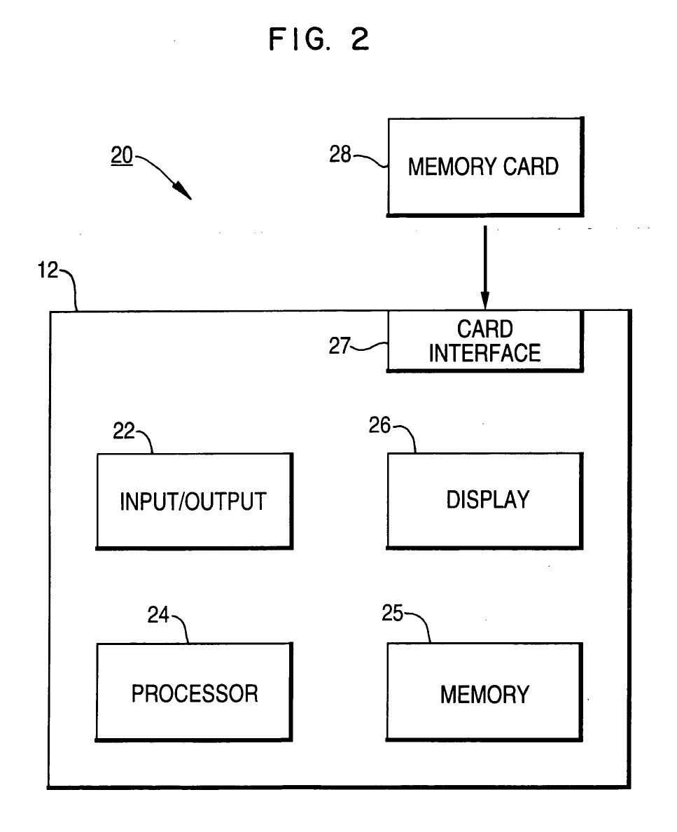

FIG. 2 is a block diagram 20 of the scan tool 10 according to an embodiment of the invention. The block diagram illustrates the basic major components of the scan tool, such as the housing 12, input/output 22, a processor 24, a memory 25, a display 26, a card reader 27 and a memory card 28. The input/output can receive information from external devices, such as the ECU or the user interface 16, while the output can, for example, present information, such as data collected from the ECU on the display 26 or transmit data to an external device. The processor 24 can be any type of processor that is appropriate for the scan tool, such as processors from Motorola, and/or field programmable gate array (FPGA). The processor can communicate with the input/output, the memory 25, the display 26, the card reader 27 and the memory card 28. Memory 25 can be any type of memory, including RAM (random access memory), ROM (read only memory), flash, bios, etc. or a combination thereof. The memory can store the software that is required for the scan tool to work or data received from the ECU or other devices. The display 26 can display the data collected from the ECU or other devices. The display can be any type of display, such as LCD, VGA, plasma, etc. The card reader 27 can communicate with the memory card 28, which can be compact flash, SD (secure digital) card, memory stick, flash drive, flash memory or any other type of memory media. The memory card can be removable from card interface 27 and can contain data, software, information, authorization data or any other type of information desired by the user.

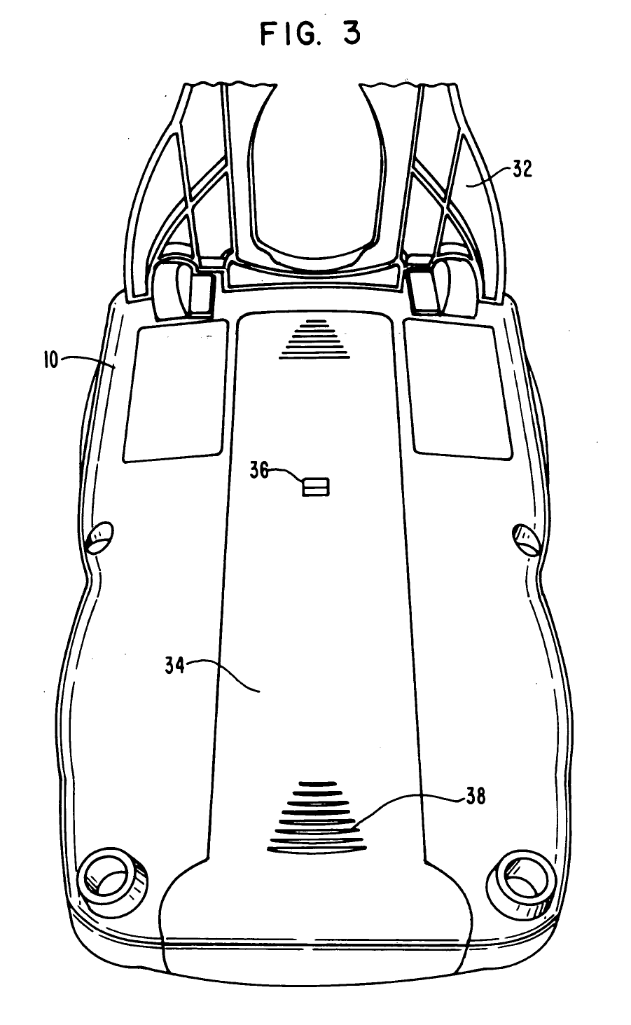

FIG. 3 is a rear view of the scan tool 10 according to an embodiment of the invention. In the rear of the scan tool 10, a stand 32 is shown in the deployed position and can be pivotally connected to the housing. The stand 32 allows the user to position the scan tool at a desired angle for viewing and hands-free operation. The stand 32 can be stored flush against a battery cover 34 when not in use. A lock member 36 is provided on an outside surface of the battery cover 34 to mate with a lock receiving portion (not shown) on the stand 32 to temporarily lock the stand 32 flush against the battery cover for storing.

The battery cover 34 provides a cover for the batteries that are utilized by the scan tool. The battery cover 34 is removable so that the user can have access to the battery compartment and the card reader, which can be integrated with the battery compartment. The battery cover can be made from any material including the same material as the scan tool. The battery cover can be coupled to the scan tool through conventional means. The battery cover 34 may also have on its outside surface ridges 38 that interact with a finger of the user to facilitate the removable or replacement of the battery cover. The ridges 38 can be placed at any point on the outer surface of the battery cover as desired by the user, Additionally, the battery cover 34 may at a first end be narrower than at a second end. The second end may be wider in order to cover the card reader. The battery cover 34 can also cover a portion of the battery compartment and the card reader.

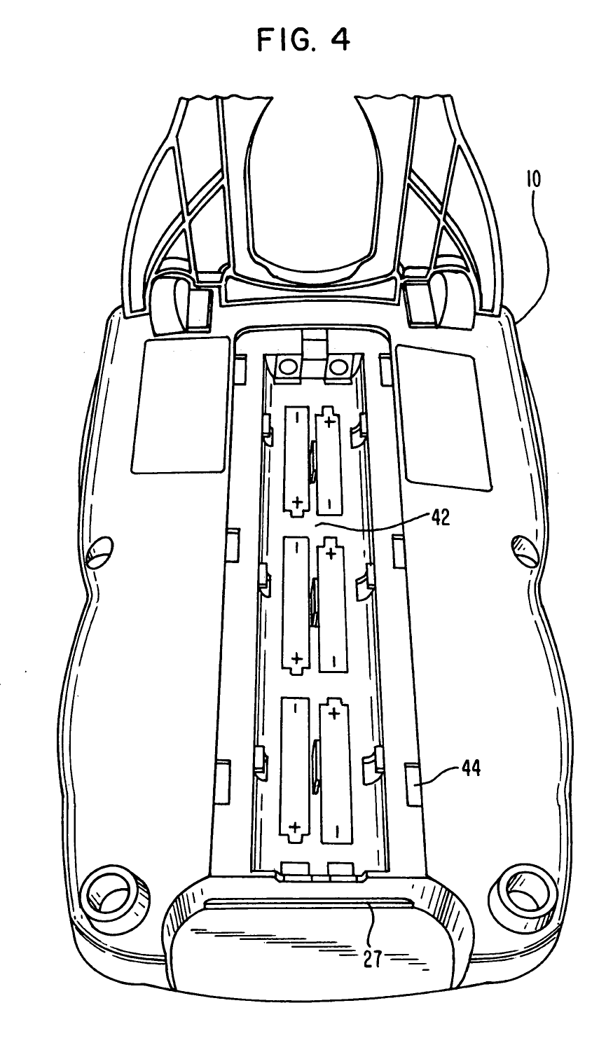

FIG. 4 illustrates the scan tool with the battery cover 34 removed. With the battery cover 34 removed, a battery compartment 42, latch receiving members 44 and the card reader 27 are shown in FIG. 4. The battery compartment holds the battery required to operate the scan tool. The battery can be any type, such as AA, AAA, C, D, 9V, etc. The latch receiving members receive the corresponding latches (not shown) on the battery cover 34 in order to secure the battery cover to the scan tool. The card reader 27 as previously stated can receive any type of memory card.

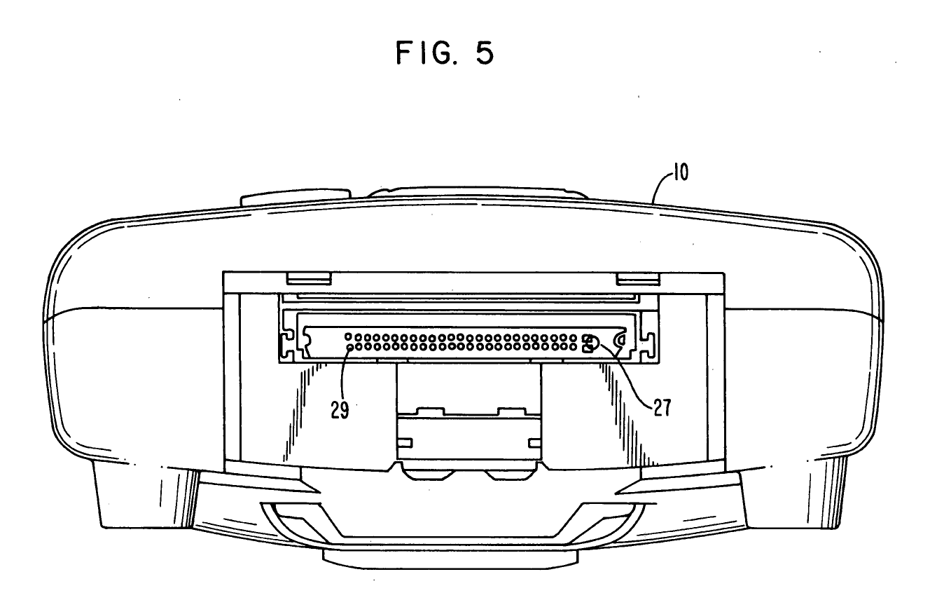

FIG. 5 illustrates an end view of the scan tool 10 with the battery cover 34 removed according to an embodiment of the invention. With the battery cover 34 removed, the user can access the card reader 27 to remove or insert the memory card. The card reader 27 can include various pins 29 or similar components in order to communicate with the various memory cards. The card reader 27 can be an integrated part of the battery compartment or separated therefrom. The card reader 27 can be any size to match the memory card. Additionally, the card reader can be constructed and arranged to receive multiple memory cards at a time by including various sizes and designs in its construction. Although, the card reader is shown recessed within the scan tool, a person skilled in the art will recognize that the card reader can be as close to a surface of the scan tool as possible so long as there is enough room for the battery cover to cover it.

In other embodiments, the card reader may be located in other parts of the scan tool where the batteries are also located. The batteries can also act as the cover for the card reader, wherein the batteries are seated or positioned over the top of the card reader. Thus, for card reader access, the batteries are removed to expose the card reader.

The battery cover protects the card reader from dust or other contaminants when no memory card is present. Additionally, the battery cover prevents the memory card from falling out during use. If the card memory falls out during use, such as while software is being uploaded, it can damage the scan tool or require the entire software to be reloaded onto the scan tool, thus, wasting time of the user. The battery cover also prevents the memory card from disengaging from the card reader should the scan tool is accidentally dropped. Further, by using a battery cover, no additional design is required and thereby saving time and money.

In operation, the user can remove the battery cover from the housing, thereby exposing the card reader. The user then inserts the appropriate memory card into the card reader. Once a good connection is established between the memory card and the card reader, the user can replace the battery cover. With the battery cover in place, the memory card is prevented from disengaging from the card reader until the battery cover is removed.

To remove the memory card from the card reader, the user again removes the battery cover from the housing, thereby exposing the card reader. The user then removes the memory card from the card reader. At this point, the user can replace the memory card with another memory card, if desired. Afterwards, the user can replace the battery cover once again. If no memory card is present in the card reader, than the battery cover can prevent dust and other contaminants from entering the card reader. If a memory card is present in the card reader, then the cover prevents the memory from disengaging from the card reader.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A scan tool, comprising:
a housing to contain components of the scan tool;
a card reader contained in the housing and configured to receive a memory card; and
a cover that covers at least a portion of a battery compartment and at least a portion of the card reader.

2. The scan tool of claim 1, wherein the battery compartment and the card reader are integral with each other.

3. The scan tool of claim 1, wherein the card reader is recessed within the housing.

4. The scan tool of claim 1, wherein the memory card is one of compact flash, SD card, memory stick, flash drive, flash memory or any other type of memory media.

5. The scan tool of claim 1, wherein the card reader is located at an end of the scan tool.

6. The scan tool of claim 1, wherein the card reader is located within the battery compartment.

7. The scan tool of claim 1, wherein the battery cover includes a protruding member to mate with a protruding receiving member on a stand that is pivotally connected to the housing.

8. A method of preventing a memory card from disengaging from a scan tool, comprising:
providing a card reader within a housing of the scan tool, the card reader is configured to communicate with the memory card;
inserting the memory card into the card reader; and
preventing the memory card from disengaging the card reader with a battery cover that is received by the housing.

9. The method of claim 8, wherein preventing the memory card from disengaging the card reader further comprises preventing at least one battery from disengaging from a battery compartment that is located in the housing.

10. The method of claim 8, wherein providing the card reader further comprises providing the card reader that is integral with a battery compartment located in the housing.

11. The method of claim 8, wherein providing the card reader further comprises providing the card reader within a battery compartment located in the housing.

12. A scan tool system, comprising:
means for housing that contains components means of the scan tool;
means for reading a memory storing means that is contained in the means for housing and configured to receive the memory storing means; and
means for covering that covers at least a portion of a battery containing means and at least a portion of means for reading.

13. The scan tool system of claim 12, wherein the battery containing means and the means for reading are integral with each other.

14. The scan tool system of claim 12, wherein the means for reading is recessed within the means for housing.

15. The scan tool system of claim 12, wherein the memory storing means is one of the following compact flash, SD card, memory stick, flash drive, flash memory and any other type of memory media.

16. The scan tool of claim 12, wherein the means for reading is located at an end of the scan tool.

17. The scan tool of claim 12, wherein the means for reading is located within the battery containing means.

18. The scan tool of claim 12, wherein the means for covering includes a protruding member means to mate with a protruding receiving member means on a means for supporting that is pivotally connected to the means for housing.

19. The scan tool of claim 12, wherein the means for covering is narrower at one end than at a second end.

20. The scan tool of claim 12, wherein the means for reading is configured to more than one memory card at a time.
